(19) United States
(12) Patent Application Publication
(10) Pub. No.: US 2024/0386533 A1
(43) Pub. Date: Nov. 21, 2024

(54) METHOD AND APPARATUS WITH ADAPTIVE FREQUENCY FILTERING FOR ROBUST IMAGE RECONSTRUCTION

(71) Applicants: Samsung Electronics Co., Ltd., Suwon-si (KR); Seoul National University R&DB Foundation, Seoul (KR)

(72) Inventors: Jaehyoung YOO, Suwon-si (KR); Donghun RYOU, Seoul (KR); Hyewon YOO, Seoul (KR); Bohyung HAN, Seoul (KR)

(73) Assignees: Samsung Electronics Co., Ltd., Suwon-si (KR); Seoul National University R&DB Foundation, Seoul (KR)

(21) Appl. No.: 18/509,534

(22) Filed: Nov. 15, 2023

(30) Foreign Application Priority Data
May 15, 2023 (KR) 10-2023-0062592
Aug. 24, 2023 (KR) 10-2023-0111196

(51) Int. Cl. G06T 5/00; G06T 5/10; G06T 5/20

(52) U.S. Cl. CPC G06T 5/70; G06T 5/10; G06T 5/20; G06T 2207/20081; G06T 2207/20084

(57) ABSTRACT

An electronic device includes: one or more processors configured to: generate a transformed frequency image by transforming an input image into a frequency domain; obtain a frequency filter corresponding to the input image by inputting the generated transformed frequency image to a filter generation neural network; and generate an output image in which a noise distribution of the input image is normalized by applying the obtained frequency filter to the generated transformed frequency image.

### CROSS-REFERENCE TO RELATED APPLICATIONS

This application claims the benefit under 35 USC § 119 (a) of Korean Patent Application No. 10-2023-0062592 filed on May 15, 2023, and Korean Patent Application No. 10-2023-0111196filed on Aug. 24, 2023, in the Korean Intellectual Property Office, the entire disclosures of which are incorporated herein by reference for all purposes.

### BACKGROUND

### 1. Field

The following description relates to a method and apparatus with adaptive frequency filtering for robust image reconstruction.

### 2. Description of Related Art

An input image captured by a camera may include various types of noise. For example, there may be shot noise occurring when light is detected by a photodiode in an image sensor, circuit noise occurring when an analog signal is converted to a digital signal, and quantization noise occurring when a digital signal is quantized and represented. A method of removing noise included in an image may be a denoising method of removing noise included in an input image using a denoising neural network based on a convolutional neural network (CNN). However, when removing noise from an input image using the denoising neural network, the denoising neural network may have a desirable denoising performance for an input image having a similar noise distribution to that of images used for training but may have a degrading denoising performance for an input image having a different noise distribution from that of the images used for training.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, an electronic device includes: one or more processors configured to: generate a transformed frequency image by transforming an input image into a frequency domain; obtain a frequency filter corresponding to the input image by inputting the generated transformed frequency image to a filter generation neural network; and generate an output image in which a noise distribution of the input image is normalized by applying the obtained frequency filter to the generated transformed frequency image.

The electronic device may includes: an image sensor comprising a plurality of photodiodes, wherein the one or more processors are configured to generate the input image using the plurality of photodiodes of the image sensor.

The one or more processors may be configured to generate a denoised image in which noise is removed from the input image by inputting the generated output image to a denoising neural network.

The one or more processors may be configured to train the filter generation neural network and the denoising neural network together based on a loss calculated using the generated denoised image and a true denoised image mapped to the input image.

The one or more processors may be configured to train the filter generation neural network based on a loss calculated using the generated denoised image and a true denoised image mapped to the input image.

The one or more processors may be configured to train the filter generation neural network based on a loss calculated using the generated output image and a true output image mapped to the input image.

For the generating of the output image, the one or more processors may be configured to: generate an intermediate image in the frequency domain by applying the obtained frequency filter to the generated transformed frequency image; and generate the output image by transforming the generated intermediate image into a spatial domain.

The filter generation neural network may include one or more convolutional neural networks (CNNs) and a fully connected layer connected to the one or more CNNs.

First output data output from the fully connected layer may indicate a frequency range of the frequency domain in the frequency filter, and second output data output from the fully connected layer may indicate a weighted value of a component corresponding to the frequency range indicated by the first output data.

For the obtaining of the frequency filter, the one or more processors may be configured to maintain the component in the frequency filter in response to the weighted value being greater than or equal to a threshold.

The filter generation neural network may be configured to output different frequency filters according to a noise distribution of an image input to the filter generation neural network.

In one or more general aspects, an electronic device includes: one or more processors configured to: generate a temporary transformed frequency image by transforming a training input image into a frequency domain, obtain a temporary frequency filter by inputting the generated temporary transformed frequency image to a filter generation neural network, generate a temporary output image by applying the obtained temporary frequency filter to the generated temporary transformed frequency image, and generate a temporary denoised image by inputting the generated temporary output image to a denoising neural network; and train the filter generation neural network and the denoising neural network together based on a loss determined using the generated temporary denoised image and a true denoised image mapped to the training input image.

In one or more general aspects, a processor-implemented method includes: generating a transformed frequency image by transforming an input image into a frequency domain; obtaining a frequency filter corresponding to the input image by inputting the generated transformed frequency image to a filter generation neural network; and generating an output image in which a noise distribution of the input image is normalized by applying the obtained frequency filter to the generated transformed frequency image.

The method may include generating a denoised image in which noise is removed from the input image by inputting the generated output image to a denoising neural network.

The generating of the output image may include: generating an intermediate image in the frequency domain by applying the obtained frequency filter to the generated transformed frequency image; and generating the output image by transforming the generated intermediate image into a spatial domain.

The filter generation neural network may include one or more convolutional neural networks (CNNs) and a fully connected layer connected to the one or more CNNs.

First output data output from the fully connected layer may indicate a frequency range of the frequency domain in the frequency filter, and second output data output from the fully connected layer indicates a weighted value of a component corresponding to the frequency range determined by the first output data.

The filter generation neural network may be configured to output different frequency filters according to a noise distribution of an image input to the filter generation neural network.

In one or more general aspects, a non-transitory computer-readable storage medium stores instructions that, when executed by a processor, configure the processor to perform any one, any combination, or all of operations and/or methods described herein.

In one or more general aspects, a processor-implemented method includes: generating a temporary transformed frequency image by transforming a training input image into a frequency domain, obtaining a temporary frequency filter by inputting the generated temporary transformed frequency image to a filter generation neural network, generating a temporary output image by applying the obtained temporary frequency filter to the generated temporary transformed frequency image, and generating a temporary denoised image by inputting the generated temporary output image to a denoising neural network; and training the filter generation neural network and the denoising neural network together based on a loss determined using the generated temporary denoised image and a true denoised image mapped to the training input image.

Other features and aspects will be apparent from the following detailed description, the drawings, and the claims.

### BRIEF DESCRIPTION OF THE DRAWINGS

FIG. 1 illustrates an example method of denoising an input image by an electronic device according to one or more example embodiments.

FIG. 2 illustrates an example of obtaining a denoised image in which noise is removed from an input image by an electronic device according to one or more example embodiments.

FIG. 3 illustrates an example structure of a filter generation neural network according to one or more example embodiments.

FIG. 4 illustrates an example of training a filter generation neural network by an electronic device according to one or more example embodiments.

FIG. 5 illustrates examples of an input image, a denoised image, a noise distribution of an input image, and a noise distribution of a denoised image according to one or more example embodiments.

FIG. 6 illustrates an example structure of an electronic device according to one or more example embodiments.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known, after an understanding of the disclosure of this application, may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof. The use of the term “may” herein with respect to an example or embodiment (for example, as to what an example or embodiment may include or implement) means that at least one example or embodiment exists where such a feature is included or implemented, while all examples are not limited thereto.

Throughout the specification, when an element is described as “connected to” or “coupled to” another element, it may be directly “connected to” or “coupled to” the other component, or there may be one or more other components intervening therebetween. In contrast, when an element is described as “directly connected to” or “directly coupled to” another element, there can be no other elements intervening therebetween. Likewise, similar expressions, for example, “between” and “immediately between,” and “adjacent to” and “immediately adjacent to,” are also to be construed in the same way. As used herein, the term “and/or” includes any one and any combination of any two or more of the associated listed items.

Although terms such as “first,” “second,” and “third,” or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish one member, component, region, layer, or section from another member, component, region, layer, or section. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein.

Also, in the description of example embodiments, detailed description of structures or functions that are thereby known after an understanding of the disclosure of the present application will be omitted when it is deemed that such description will cause ambiguous interpretation of the example embodiments.

Hereinafter, examples will be described in detail with reference to the accompanying drawings, and like reference numerals in the drawings refer to like elements throughout.

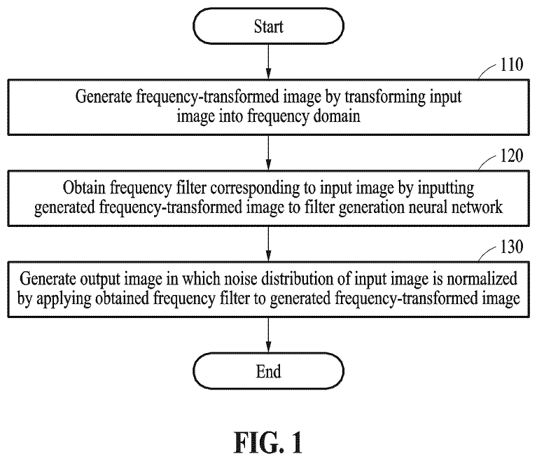

FIG. 1 illustrates an example method of denoising an input image by an electronic device according to one or more example embodiments.

An image generated by a camera may include various types of noise. Noise included in an image may be removed using a denoising neural network based on a convolutional neural network (CNN). The denoising neural network may refer to one or more models having a machine learning structure configured to extract a denoised image in which noise is removed from an input image in response to the image being input.

The denoising neural network may be overfitted to a noise distribution of training images used for training. That is, the denoising neural network may effectively perform denoising on an image having a similar noise distribution to that of the training images but may not effectively perform denoising on an image having a different noise distribution from that of the training images. For example, when the denoising neural network is trained with training images including Gaussian noise that follows a normal distribution with a standard deviation of 10, the denoising neural network may not be able to effectively denoise an image having Gaussian noise that follows a normal distribution with a standard deviation of 15. For another example, when the denoising neural network is trained with training images having real noise, the denoising neural network may not be able to effectively denoise an image having synthetic noise.

An electronic device of one or more embodiments may solve such issues described above by normalizing a noise distribution of an image. When a noise distribution of an input image is normalized, the electronic device may input an image having the normalized noise distribution to the denoising neural network that is trained in advance. That is, the electronic device of one or more embodiments may transform a noise distribution of an image into a noise distribution on which denoising may be effectively performed by the denoising neural network. The denoising neural network may effectively perform denoising on an image in which a noise distribution is normalized from an input image.

Referring to FIG. 1, in operation 110, the electronic device may generate a transformed frequency image (e.g., a frequency-transformed image) by transforming an input image into a frequency domain.

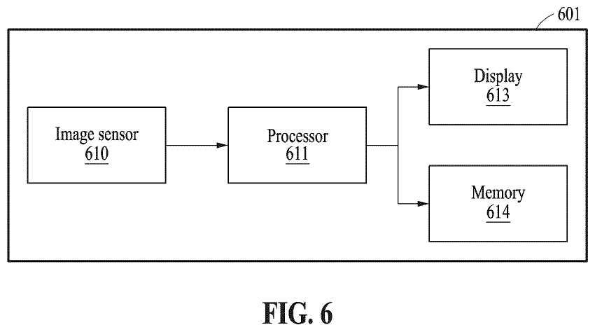

In an example embodiment, the electronic device may obtain an input image. For example, the electronic device (e.g., an electronic device 601 of FIG. 6) may obtain an input image from a camera provided inside the electronic device. An image sensor (e.g., an image sensor 610 of FIG. 6) included in the camera may include a plurality of photodiodes. The plurality of photodiodes included in the image sensor may receive light and generate an input image of an external object. For another example, the electronic device may obtain an input image from an external electronic device. The input image used herein may be data in a spatial domain.

In an example embodiment, the electronic device may transform the input image from the spatial domain to the frequency domain using a Fourier transform. In an example, transforming the input image from the spatial domain to the frequency domain may include applying a frequency analysis using a change in brightness of a pixel as a signal while following the input image in an x-axis or y-axis direction. The intensity of each frequency component obtained through the Fourier transform may be defined as a spectrum, and the spectrum may be represented as a transformed frequency image.

In operation 120, the electronic device may obtain (e.g., generate or determine) a frequency filter (or a target filter) corresponding to the input image by inputting the generated transformed frequency image to a first filter generation neural network.

In an example embodiment, the first filter generation neural network may be one or more models having a machine learning structure configured to extract a frequency filter for denoising an input image in response to an input of the image which is data in the frequency domain. The first filter generation neural network may generate the frequency filter corresponding to the input image by performing a machine learning model-based operation on the input image. The frequency filter may pass or block a specific frequency band. For example, the first filter generation neural network may generate various types of frequency filters including, as non-limiting examples, a band-pass filter (BPF), a band reject filter (BRF), a high-pass filter (HPF), and/or a low-pass filter (LPF).

In operation 130, the electronic device may generate an output image in which a noise distribution of the input image is normalized by applying the obtained frequency filter to the generated transformed frequency image. The electronic device may perform frequency filtering on the transformed frequency image by applying the frequency filter to the transformed frequency image. The electronic device may enhance or attenuate individual frequency regions in the transformed frequency image. For example, the frequency filter may be represented in the form of an image having the same size as the transformed frequency image. In an example, applying the frequency filter to the transformed frequency image may include multiplying the transformed frequency image by the frequency filter.

In an example embodiment, the electronic device may input the output image in which the noise distribution of the input image is normalized to a denoising neural network. The denoising neural network may output a denoised image in which noise is removed from the output image by effectively removing noise from the output image.

As described above, the electronic device may input the transformed frequency image of the input image to the filter generation neural network to normalize a noise distribution of the input image, and may obtain the frequency filter corresponding to the input image from the filter generation neural network.

In a similar way, the electronic device may perform deblurring on an input image. Deblurring may refer to a process of removing blurs from an image. In an example embodiment, the electronic device may generate a transformed frequency image by transforming an input image into the frequency domain, and obtain a frequency filter corresponding to the input image by inputting the generated transformed frequency image to a second filter generation neural network. The second filter generation neural network may be one or more models having a machine learning structure configured to extract a frequency filter for deblurring the input image by which a blur included in the input image is removed.

Also, in a similar way, the electronic device may perform upscaling on an input image. Upscaling may refer to a process of increasing the resolution of an input image. In an example embodiment, the electronic device may generate a transformed frequency image by transforming an input image into the frequency domain, and obtain a frequency filter corresponding to the input image by inputting the generated transformed frequency image to a third filter generation neural network. The third filter generation neural network may be one or more models having a machine learning structure configured to extract a frequency filter for upscaling the input image by which the resolution of the input image is increased.

The first filter generation neural network for denoising the input image, the second filter generation neural network for deblurring the input image, and the third filter generation neural network for upscaling the input image may be different from one another.

In an example embodiment, the electronic device may store a plurality of filter generation neural networks (e.g., the first filter generation neural network, the second filter generation neural network, and the third filter generation neural network). The electronic device may select a filter generation neural network from among the plurality of filter generation neural networks according to a task to be performed on an input image. The electronic device may obtain a frequency filter corresponding to the input image by inputting, to the selected filter generation neural network, a transformed frequency image corresponding to the input image.

Each of the plurality of filter generation neural networks may correspond to one task. For example, the first filter generation neural network may correspond to a noise distribution normalizing task, the second filter generation neural network may correspond to a deblurring task, and the third filter generation neural network may correspond to an upscaling task. In this example, when a task to be performed on an input image is upscaling, the electronic device may select the third filter generation neural network from among the plurality of filter generation neural networks.

The following describes how an electronic device performs a task of normalizing a noise distribution of an input image.

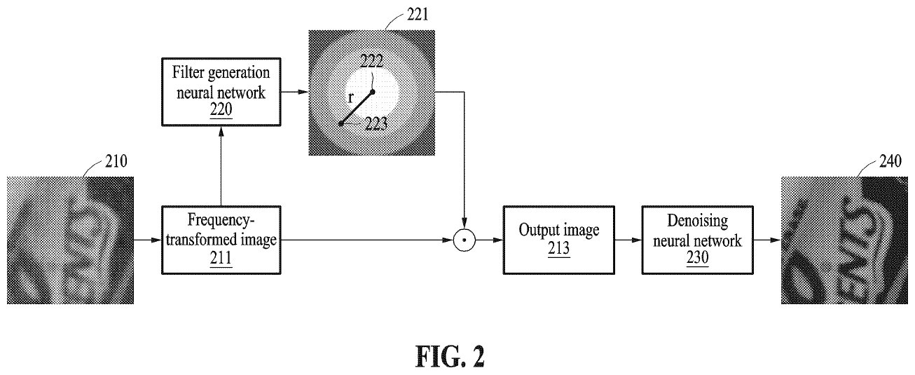

FIG. 2 illustrates an example of obtaining a denoised image in which noise is removed from an input image by an electronic device according to one or more example embodiments.

An electronic device may first transform, into a frequency domain, an input image 210 that is data in a spatial domain. The electronic device may generate a transformed frequency image (e.g., a frequency-transformed image) 211 by transforming the input image 210 into the frequency domain. That is, the transformed frequency image 211 may be data in the frequency domain. The electronic device may obtain a frequency filter 221 corresponding to the input image 210 by inputting the transformed frequency image 211 to a filter generation neural network 220. The frequency filter 221 may be a frequency filter for denoising the transformed frequency image 211.

The frequency filter 221 may be represented in the form of an image having the same size as the transformed frequency image 211. An entire area of the frequency filter 221 may be divided into a preset number of regions. A region in the frequency filter 221 may correspond to an individual frequency band. An entire frequency band of the frequency filter 221 output from the filter generation neural network 220 may be divided into a preset number of frequency bands, and a weighted value may be individually set for each divided frequency band.

For example, the entire area of the frequency filter 221 may be divided into four regions. In this example, a first region may be a set of points whose distance from a center point 222 is ×1 or less in the frequency filter 221; a second region may be a set of points whose distance from the center point 222 is greater than X1, and less than or equal to x2, in the frequency filter 221; a third region may be a set of points whose distance from the center point 222 is greater than x2,and less than or equal to x3, in the frequency filter 221; and a fourth region may be a region outside the third region (e.g., a set of points whose distance from the center point 222 is greater than x3). In this example, x2 may be greater than x1, and x3 may be greater than x2. The same weighted value may be set for points included in the same region within the frequency filter 221.

For another example, the frequency filter 221 corresponding to the transformed frequency image 211 may be an LPF. A transfer function of the LPF may be expressed as Equation 1 below, for example.

$$H ( u , v ) = \{ \begin{matrix}1 if D ( u , v ) \leq {D}_{0} \\ 0 if D ( u , v ) > {D}_{0}\end{matrix} \qquad Equation 1$$

In Equation 1, u and v may represent the coordinate values of the frequency component, H (u, v) represents the transfer function at the frequency coordinate value (u, v), and D (u, v) may represent the distance between the (u, v) coordinate and the origin in the frequency domain. According to Equation 1 above, the frequency filter 221 may pass a frequency band corresponding to an inner region with a radius D₀ in the transformed frequency image 211 and block a frequency band corresponding to a remaining region other than the inner region with the radius D₀ in the transformed frequency image 211. That is, the entire area of the frequency filter 221 may be divided into two regions. A weighted value of 1 may be set for a point included in an inner region of a circle with a radius D₀ from the center of the frequency filter 221, and a weighted value of 0 may be set for a point included in an outer region of the circle.

For another example, the frequency filter 221 corresponding to the transformed frequency image 211 may be a Gaussian LPF. A transfer function of the Gaussian LPF may be expressed as Equation 2 below, for example.

$$H ( u , v ) = {e}^{- {D}^{2} ( u , v ) / 2 {D}_{0}^{2}} \qquad Equation 2$$

In a case of the frequency filter 221 being a Gaussian LPF, the frequency filter 221 may pass a frequency band corresponding to a central region in the transformed frequency image 211 and block a frequency band corresponding to a remaining region in the transformed frequency image 211. Using the Gaussian LPF may block edge information that may be present in a high-frequency region to acquire a smoothing effect.

In an example embodiment, the electronic device may apply the frequency filter 221 to the transformed frequency image 211 to generate an output image 213 in which a noise distribution of the input image 210 is normalized. For example, the electronic device may generate an intermediate image that is data in the frequency domain by multiplying the transformed frequency image 211 by the frequency filter 221, and the electronic device may generate the output image 213 by transforming the generated intermediate image into the spatial domain. The electronic device may transform the intermediate image from the frequency domain to the spatial domain using an inverse Fourier transform. The output image 213 may be an image with a noise distribution normalized from the input image 210.

The electronic device may input the output image 213 with the normalized noise distribution to a denoising neural network 230. The electronic device may input the output image 213 to the denoising neural network 230 to obtain a denoised image 240 in which noise is removed from the input image 210.

As described above, the filter generation neural network 220 and the denoising neural network 213 may be implemented independently of each other. However, examples are not limited thereto, and the filter generation neural network 220 and the denoising neural network 230 may be implemented as a single integrated network.

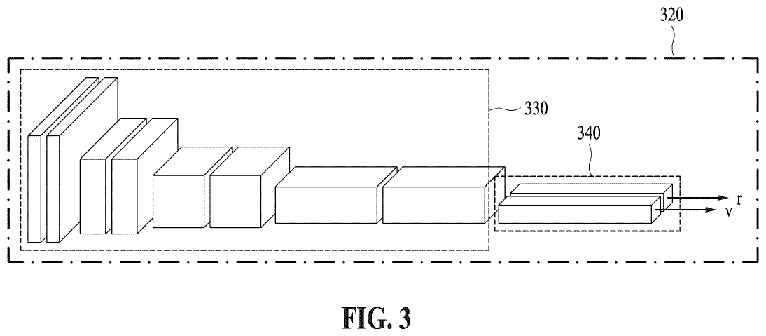

FIG. 3 illustrates an example structure of a filter generation neural network according to one or more example embodiments.

In an example embodiment, a filter generation neural network 320 may include at least one CNN 330 and a fully connected layer 340 connected to the at least one CNN 330. The fully connected layer 340 may include a plurality of layers. The fully connected layer 340 may receive, as an input, an output of the at least one CNN 330.

In an example embodiment, two output data (e.g., first output data and second output data) may be output from the fully connected layer 340. The first output data output from the fully connected layer 340 may correspond to a radius r in a frequency filter (e.g., the frequency filter 221 of FIG. 2). The radius used herein may refer to a distance between one point (e.g., the point 223 of FIG. 2) in the frequency filter (e.g., the frequency filter 221 of FIG. 2) and a center point (e.g., the center point 222 of FIG. 2) of the frequency filter. That is, the first output data may determine a frequency range of a frequency domain in the frequency filter. The second output data output from the fully connected layer 340 may represent a weighted value v corresponding to the radius r corresponding to the first output data in the frequency filter (e.g., the frequency filter 221 of FIG. 2). That is, the weight value corresponding to one point (e.g., the point 223 of FIG. 2) in the frequency filter (e.g., the frequency filter 221 of FIG. 2) may be determined from the second output data. That is, the second output data may determine the importance of a component corresponding to the frequency range determined by the first output data. For example, the weighted value may increase in response to an increase in the importance of a component corresponding to a specific frequency range, and the weighted value may decrease in response to a decrease in the importance of a component corresponding to a specific frequency range.

In an example embodiment, the output data (e.g., the first output data and the second output data) of the fully connected layer 340 may be used to calculate weighted values respectively corresponding to a plurality of points included in the frequency filter. For example, using, as a radius, a distance by which one point included in the frequency filter is separated from an origin point, a weighted value corresponding to the radius may be calculated as a weighted value corresponding to the point. The filter generation neural network 320 may output the frequency filter such that an important frequency component is to be maintained in an image input to the filter generation neural network 320. That is, the frequency filter output by the filter generation neural network 320 may maintain an important low-frequency component and an important high-frequency component in an image. For example, the electronic device may maintain a component in the frequency filter in response to a weighted value of the component being greater than or equal to a threshold.

In an example embodiment, the filter generation neural network 320 may output different frequency filters according to a noise distribution of an image input to the filter generation neural network 320. For example, in consideration that most of noise included in an image is mainly distributed in a high-frequency region, the filter generation neural network 320 may be configured such that a frequency filter output by the filter generation neural network 320 passes more components in a low-frequency band than components in a high-frequency band.

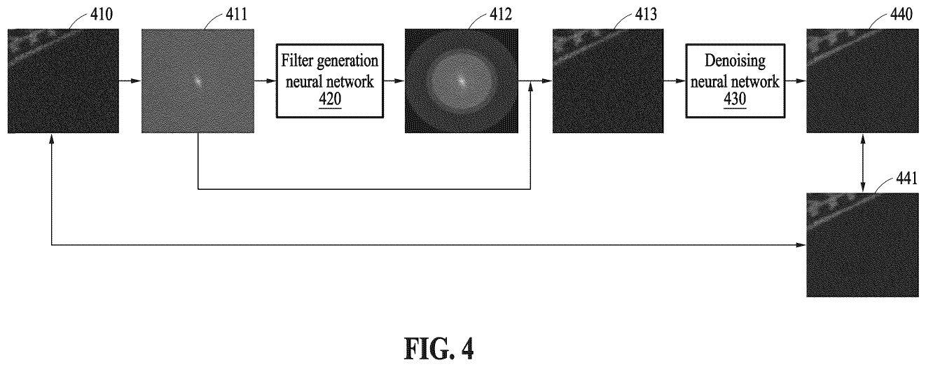

FIG. 4 illustrates an example of training a filter generation neural network by an electronic device according to one or more example embodiments.

In an example embodiment, an electronic device may train a filter generation neural network 420. The electronic device may train the filter generation neural network 420 using, as training data, a training input image 410 and a true denoised image 441 mapped to the training input image 410. In an example, the true denoised image 441 may be an image with noise removed from the training input image 410.

In an example embodiment, the electronic device may train the filter generation neural network 420 and a denoising neural network 430 together. The electronic device may calculate a loss using training data including a training image 411 and train the filter generation neural network 420 and the denoising neural network 430 together using the calculated loss. The electronic device may generate a trained filter generation neural network 420 by repeatedly updating parameters of each of the filter generation neural network 420 and the denoising neural network 430 until the loss converges and/or until the loss becomes less than a threshold loss.

The following describes an example of how a loss is calculated. In an example embodiment, the electronic device may generate a temporary transformed frequency image 411 by transforming the training image 410 included in the training data into a frequency domain. The electronic device may obtain a temporary frequency filter 412 to be applied to the temporary transformed frequency image 411 by inputting the temporary transformed frequency image 411 in the frequency domain to the filter generation neural network 420. The electronic device may generate a temporary output image 413 by applying the obtained temporary frequency filter 412 to the generated temporary transformed frequency image 411. The electronic device may obtain a temporary denoised image 440 by inputting the temporary output image 413 to the denoising neural network 430. The electronic device may calculate a loss using the obtained temporary denoised image 440 and the true denoised image 441 mapped to the training image 410. For example, the loss may represent an error between the temporary denoised image 440 and the true denoised image 441.

In another example embodiment, the electronic device may independently train the filter generation neural network 420 separately from the denoising neural network 430. The electronic device may obtain the denoising neural network 430 that is pre-trained. That is, parameters of the obtained denoising neural network 430 may be predetermined ones, and the electronic device may update only parameters of the filter generation neural network 420. The electronic device may calculate a loss using the training data including the training image 410 and independently train the filter generation neural network 420 using the calculated loss. The loss may be calculated in a similar way described above. In an example embodiment, the electronic device may generate the temporary transformed frequency image 411 by transforming the training image 410 included in the training data into the frequency domain. The electronic device may obtain the temporary frequency filter 412 to be applied to the temporary transformed frequency image 411 by inputting the temporary transformed frequency image 411 in the frequency domain to the filter generation neural network 420. The electronic device may generate the temporary output image 413 by applying the obtained temporary frequency filter 412 to the generated temporary transformed frequency image 411. The electronic device may obtain a temporary denoised image by inputting the temporary output image 413 to a pre-trained denoising neural network (e.g., one that is different from the denoising neural network 430 before being trained). The electronic device may calculate a loss using the obtained temporary denoised image and the true denoised image 441 mapped to the training image 410. For example, the loss may represent an error between the temporary denoised image 440 and the true denoised image 441.

Furthermore, the electronic device may train the filter generation neural network 420 without using a denoising neural network. The electronic device may first normalize a noise distribution of the training image 410. For example, normalizing the noise distribution may be construed herein as transforming a previous noise distribution of the training image 410 into a standard normal distribution with a mean of zero (0) and a standard deviation of 1, but normalizing the noise distribution is not limited thereto. There may be various methods of normalizing a noise distribution, which may vary depending on the settings of the electronic device that performs training of the filter generation neural network 420. The electronic device may obtain a true output image by normalizing the noise distribution in the training image 410. In an example, the electronic device may calculate a loss using the training data including the training image 410 and a true output image corresponding to the training image 410 and may train the filter generation neural network 420 using the calculated loss. For example, the electronic device may generate the temporary transformed frequency image 411 by transforming the training image 410 into the frequency domain, and may input the temporary transformed frequency image 411 of the frequency domain to the filter generation neural network 420 to obtain the temporary frequency filter 412 to be applied to the temporary transformed frequency image 411. The electronic device may generate the temporary output image 413 by applying the obtained temporary frequency filter 412 to the generated temporary transformed frequency image 411. The electronic device may calculate the loss using the obtained temporary output image 413 and the true output image mapped to the training image 410. For example, the loss may represent an error between the temporary output image 413 and the true output image mapped to the training image 410.

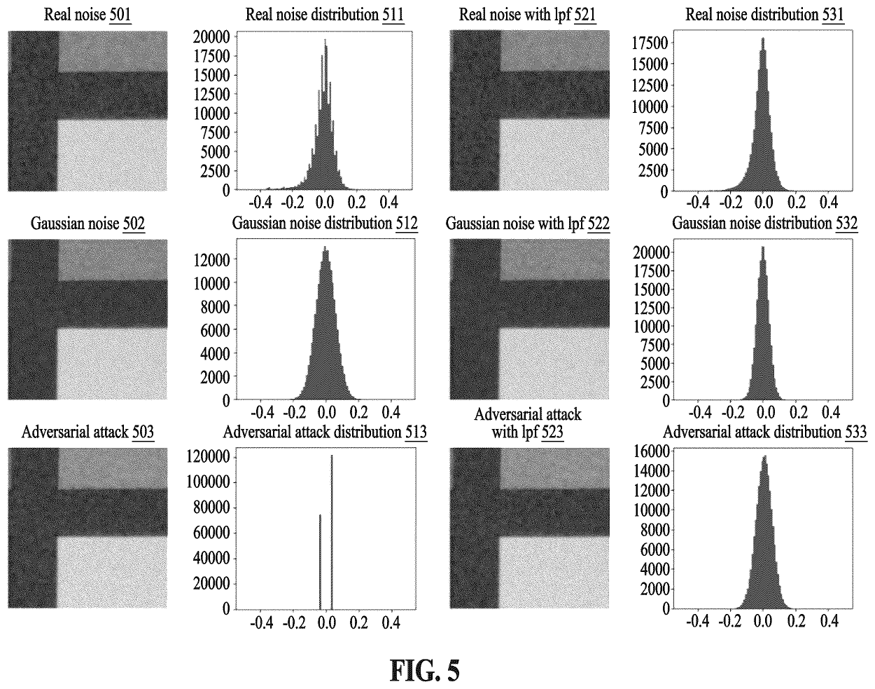

FIG. 5 illustrates examples of an input image, a denoised image, a noise distribution of an input image, and a noise distribution of a denoised image according to one or more example embodiments.

Referring to FIG. 5, input images 501, 502, and 503 may be images to which a frequency filter has not been applied, and noise distributions 511, 512, and 513 may be distributions of noise included in the input images 501, 502, and 503, respectively. In addition, output images 521, 522, and 523 may be images generated as a result of the frequency filter being applied to the input images 501, 502, and 503, respectively, and noise distributions 531, 532, and 533 may be distributions of noise included in the output images 521, 522, and 523, respectively. For example, the output image 521 may be an image to which a frequency filter corresponding to the input image 501 output from a filter generation neural network (e.g., the filter generation neural network 320 of FIG. 3) is applied to the input image 501. Similarly, the output image 522 may be an image to which a frequency filter corresponding to the input image 502 is applied to the input image 502, and the output image 523 may be an image to which a frequency filter corresponding to the input image 503 is applied to the input image 503.

For example, the input image 501 and the noise distribution 511 of the input image 501 may be derived from a real noise dataset. The input image 502 and the noise distribution 512 of the input image 502 may be generated from synthetic noise. The input image 503 and the noise distribution 513 of the input image 503 may be generated from an adversarial attack. The frequency filter output from the filter generation neural network may normalize the respective noise distributions of the input images 501, 502, and 503. Referring to FIG. 5, it may be verified that the distributions of noise included in the input images 501, 502, and 503, respectively, are normalized such that the noise distributions 531, 532, and 533 of the output images 521, 522, and 523 appear similar.

FIG. 6 illustrates an example structure of an electronic device according to one or more example embodiments.

In an example embodiment, an electronic device 601 may include an image sensor 610, a processor 611 (e.g., one or more processors), a display 613, and a memory 614 (e.g., one or more memories). For example, the electronic device 601 may be the electronic device described above with reference to FIGS. 1 to 5. The image sensor 610 may generate an input image of an external object by receiving light. The image sensor 610 may transmit the generated input image to the processor 611. The processor 611 may perform denoising on the input image received from the image sensor 610. The processor 611 may perform the operations for denoising described above with reference to FIGS. 1 to 5. The processor 611 may train a filter generation neural network using training data including a training image. The processor 611 may transmit a denoised image with noise removed from the input image to the display 613 and the memory 615. The display 613 may output the denoised image received from the processor 611. The memory 614 may store the denoised image received from the processor 611. The memory 614 may map the denoised image to the input image and store them together. In an example, the memory 614 may be or include a non-transitory computer-readable storage medium storing instructions that, when executed by the processor 611, configure the processor 611 to perform any one, any combination, or all of the operations and methods described herein with reference to FIGS. 1-5.

The electronic devices, image sensors, processors, displays, memories, electronic device 601, image sensor 610, processor 611, display 613, memory 614, and other apparatuses, devices, units, modules, and components disclosed and described herein with respect to FIGS. 1-6 are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-6 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. An electronic device comprising:
one or more processors configured to:
generate a transformed frequency image by transforming an input image into a frequency domain;
obtain a frequency filter corresponding to the input image by inputting the generated transformed frequency image to a filter generation neural network; and
generate an output image in which a noise distribution of the input image is normalized by applying the obtained frequency filter to the generated transformed frequency image.

2. The electronic device of claim 1, further comprising:
an image sensor comprising a plurality of photodiodes,
wherein the one or more processors are configured to generate the input image using the plurality of photodiodes of the image sensor.

3. The electronic device of claim 1, wherein the one or more processors are configured to generate a denoised image in which noise is removed from the input image by inputting the generated output image to a denoising neural network.

4. The electronic device of claim 3, wherein the one or more processors are configured to train the filter generation neural network and the denoising neural network together based on a loss calculated using the generated denoised image and a true denoised image mapped to the input image.

5. The electronic device of claim 3, wherein the one or more processors are configured to train the filter generation neural network based on a loss calculated using the generated denoised image and a true denoised image mapped to the input image.

6. The electronic device of claim 1, wherein the one or more processors are configured to train the filter generation neural network based on a loss calculated using the generated output image and a true output image mapped to the input image.

7. The electronic device of claim 1, wherein, for the generating of the output image, the one or more processors are configured to:
generate an intermediate image in the frequency domain by applying the obtained frequency filter to the generated transformed frequency image; and
generate the output image by transforming the generated intermediate image into a spatial domain.

8. The electronic device of claim 1, wherein the filter generation neural network comprises one or more convolutional neural networks (CNNs) and a fully connected layer connected to the one or more CNNs.

9. The electronic device of claim 8, wherein
first output data output from the fully connected layer indicates a frequency range of the frequency domain in the frequency filter, and
second output data output from the fully connected layer indicates a weighted value of a component corresponding to the frequency range indicated by the first output data.

10. The electronic device of claim 9, wherein, for the obtaining of the frequency filter, the one or more processors are configured to maintain the component in the frequency filter in response to the weighted value being greater than or equal to a threshold.

11. The electronic device of claim 1, wherein the filter generation neural network is configured to output different frequency filters according to a noise distribution of an image input to the filter generation neural network.

12. An electronic device comprising:
one or more processors configured to:
generate a temporary transformed frequency image by transforming a training input image into a frequency domain, obtain a temporary frequency filter by inputting the generated temporary transformed frequency image to a filter generation neural network, generate a temporary output image by applying the obtained temporary frequency filter to the generated temporary transformed frequency image, and generate a temporary denoised image by inputting the generated temporary output image to a denoising neural network; and
train the filter generation neural network and the denoising neural network together based on a loss determined using the generated temporary denoised image and a true denoised image mapped to the training input image.

13. A processor-implemented method comprising:
generating a transformed frequency image by transforming an input image into a frequency domain;
obtaining a frequency filter corresponding to the input image by inputting the generated transformed frequency image to a filter generation neural network; and
generating an output image in which a noise distribution of the input image is normalized by applying the obtained frequency filter to the generated transformed frequency image.

14. The method of claim 13, further comprising generating a denoised image in which noise is removed from the input image by inputting the generated output image to a denoising neural network.

15. The method of claim 13, wherein the generating of the output image comprises:
generating an intermediate image in the frequency domain by applying the obtained frequency filter to the generated transformed frequency image; and
generating the output image by transforming the generated intermediate image into a spatial domain.

16. The method of claim 13, wherein the filter generation neural network comprises one or more convolutional neural networks (CNNs) and a fully connected layer connected to the one or more CNNs.

17. The method of claim 16, wherein
first output data output from the fully connected layer indicates a frequency range of the frequency domain in the frequency filter, and
second output data output from the fully connected layer indicates a weighted value of a component corresponding to the frequency range determined by the first output data.

18. The method of claim 13, wherein the filter generation neural network is configured to output different frequency filters according to a noise distribution of an image input to the filter generation neural network.

19. A non-transitory computer-readable storage medium storing instructions that, when executed by one or more processors, configure the one or more processors to perform the method of claim 13.

20. A processor-implemented method comprising:
generating a temporary transformed frequency image by transforming a training input image into a frequency domain, obtaining a temporary frequency filter by inputting the generated temporary transformed frequency image to a filter generation neural network, generating a temporary output image by applying the obtained temporary frequency filter to the generated temporary transformed frequency image, and generating a temporary denoised image by inputting the generated temporary output image to a denoising neural network; and
training the filter generation neural network and the denoising neural network together based on a loss determined using the generated temporary denoised image and a true denoised image mapped to the training input image.
